(19) United States
(12) Patent Application Publication
(10) Pub. No.: US 2026/0128926 A1
(43) Pub. Date: May 7, 2026

(54) COMMUNICATION NETWORK FOR A MOTOR VEHICLE, MOTOR VEHICLE AND METHOD FOR COMMUNICATING DATA IN A COMMUNICATION NETWORK

(71) Applicant: AUDI AG, Ingolstadt (DE)

(72) Inventors: Karsten Schmidt, Ingolstadt (DE); Christoph Vogl, Vohburg (DE)

(73) Assignee: AUDI AG, Ingolstadt (DE)

(21) Appl. No.: 19/332,864

(22) Filed: Sep. 18, 2025

(30) Foreign Application Priority Data
Sep. 23, 2024 (DE) 10 2024 127 384.4

(51) Int. Cl. H04L 12/40; H04L 9/08; H04L 9/40

(52) U.S. Cl. CPC H04L 12/40182; H04L 9/0869; H04L 9/40; H04L 2012/40215; H04L 2012/40241; H04L 2012/40273

(57) ABSTRACT

A communication network for a motor vehicle, comprising at least two parallel communication paths including a main path and a fallback path, which are designed to provide a redundant communication of data in the communication network, the communication network comprising a communication layer, which has at least one communication processor (to organize the communication of the data, and a cryptography layer, which has at least one cryptography processor to cryptographically protect the data to be communicated. The at least one cryptography processor is designed to cryptographically protect the data to be communicated along the at least two parallel communication paths by applying at least two different cryptography algorithms.

### CROSS REFERENCE TO RELATED APPLICATIONS

This application is a based upon and claims the priority benefit of German Application No. 10 2024 127 384.4 filed on Sep. 23, 2024, the entire contents of which are incorporated by reference herein.

### BACKGROUND

### 1. Field

One aspect of the invention relates to a communication network for a motor vehicle, comprising at least two parallel communication paths, in particular a main path and a fallback path, which are designed to provide a redundant communication of data in the communication network, the communication network comprising a communication layer, which has at least one communication processor for organizing the communication of the data, and a cryptography layer, which has at least one cryptography processor for cryptographically protecting the data to be communicated. Cryptographic protection can be performed using various methods, for example by creating a signature for the data and/or by way of data encryption. Other aspects of the invention relate to a motor vehicle having such a communication network and to a method for redundantly communicating data in such a communication network.

Vehicle communication today, i.e. the communication of data within communication networks within a motor vehicle, is generally protected by means of safety mechanisms (protection mechanisms). Currently, vehicles are being developed that permit autonomous driving at SAE level 3 or higher. In order to achieve the necessary safety properties for this, for example the continuous availability of data transmission, parallel transmission of data or messages via various network channels or communication paths, in particular a main path and a fallback path, is advantageous.

### 2. Description of the Related Art

Such redundant data transmission in a motor vehicle is known generally from U.S. Pat. No. 10,218,644 B1. Multiple redundant communication paths are used for data transmission here. Data transmission is nevertheless vulnerable to active attacks (security), as no additional encryption or cryptographic protection of the data is provided on the redundant communication paths.

Cryptography algorithms can be used to achieve cryptographic protection of the data.

The application of cryptography software is known, for example from DE 10 061 998 A1. That document describes a cryptography processor having multiple subunits for processing different cryptographic algorithms.

DE 10 2019 122 806 A1 also describes the application of different cryptographic algorithms. In that document, a cryptographic apparatus uses the cryptographic algorithms with different cryptographic keys for data transmission in a motor vehicle.

If cryptographic protection is provided at all in known communication networks having redundant communication paths, generally only a single cryptography algorithm is used for this purpose. However, the exclusive use of a single cryptography algorithm increases the likelihood of common cause errors occurring. Common cause errors in safety risk analysis are failures of multiple components or systems that occur as a result of a single cause of error or a single event. The failure behavior of said components or systems is thus statistically dependent on one another. Common cause errors can lead to elimination of the necessary redundancies in safety-related subsystems.

### SUMMARY

An aspect of the invention enables of the present invention is to further improve the security and reliability of data transmission in a communication network for a motor vehicle.

The object is achieved by the subject matter of the independent patent claims. Advantageous developments of the invention are described by the dependent patent claims, the description and the figures.

According to an aspect, different cryptography algorithms can be used for redundant communication paths in order to reduce common cause errors. Sensible combination of differently selected cryptography algorithms or cryptography methods can minimize the occurrence of so-called common cause errors when redundant communication is required. This improves, among other things, the feasibility of autonomous driving functions.

One aspect relates to a communication network for a motor vehicle, comprising at least two parallel communication paths, in particular a main path and a fallback path, which are designed to provide a redundant communication of data in the communication network. The communication network can also have more than two communication paths, the number of communication paths being selected by a person skilled in the art as needed. The communication paths can be in the form of cable connections, for example in the form of a 4-wire line or a 2-wire line. Preferably, a first wiring harness is used to produce a first of the communication paths, and a further wiring harness to produce a second or another of the communication paths. The communication network can connect different nodes in the motor vehicle to one another for communication purposes, for example different sensors or control units of the motor vehicle to a control apparatus of the motor vehicle. Communication via the communication paths can be unidirectional or bidirectional. On the one hand, sensor data of the sensors mentioned by way of illustration can be communicated to the control apparatus. On the other hand, the sensors can be controlled by the control apparatus via data communication, for example to carry out distance measurement during a parking process of the motor vehicle.

The communication network may be designed as a communication stack having multiple layers. In this case, a communication layer having at least one communication processor is provided for organizing the communication of the data. For this purpose, a communication algorithm can be executed by the communication processor. In this document, organizing the communication of the data is intended to mean, among other things, how data to be communicated are prioritized. In other words, the communication processor ensures that all data to be communicated via the communication network are processed in the communication network according to a predetermined communication routine. This can include conventional CAN communication.

Additionally, there is provision in the communication network for a cryptography layer having at least one cryptography processor for cryptographically protecting the data to be communicated. The cryptographic protection can comprise, for example, a signature method for creating a signature for the data to be communicated and/or encryption of the data to be communicated. The cryptography layer can be operated as part of the described communication stack or alternatively also in parallel with the communication stack.

According to another aspect of the invention, the at least one cryptography processor is designed to cryptographically protect the data to be communicated along the parallel communication paths by applying at least two different cryptography algorithms. The primary application here can be considered to be how signature calculation or signing of the data is performed. In other words, the cryptographic protection can comprise how the data are provided with a data signature for authentication. The cryptography processor thus cryptographically protects the data to be communicated along the main path by applying a first cryptography algorithm. To cryptographically protect the data to be transmitted along the fallback path, the cryptography processor according to the invention applies a second, different cryptography algorithm. There may also be provision for a multiplicity of such cryptography processors, each of which executes or applies its own cryptography algorithm, the cryptography algorithms all being able to be different. Well known cryptography methods can be used for this, for example AES (Advanced Encryption Standard) or SipHash. These methods take into account the payload of a dataset and also other factors (key and challenge). As these methods are inherently known, they are not described further here.

The invention, according to an aspect, results in the advantage that the use of different cryptography algorithms can reduce the occurrence of so-called common cause errors when redundant communication is required. This improves, among other things, the feasibility of autonomous driving functions. Additionally, the overall availability of the communication network can be increased.

The invention also comprises embodiments that result in additional advantages.

One embodiment provides for the cryptography layer to comprise a multiplicity of cryptography processors, each of the cryptography processors having a separate associated cryptography algorithm. This results in the advantage that even if one or more of the cryptography processors fail, redundant data transmission is still guaranteed. If, for example, a software error occurs in one of the cryptography processors due to a hacker attack, the other cryptography processors can continue to use their cryptography algorithms unhindered. In other words, the data that should have been encrypted by the attacked cryptography processor can then be taken on by or redirected to one or more of the other cryptography processors, and so the data communication is still guaranteed.

Similarly, the communication layer can alternatively or additionally have a multiplicity of communication processors, each of the communication processors having a separate associated communication algorithm. In other words, each of the communication processors can also execute different communication algorithms to organize the data transmission. As such, additional redundancy in the data transmission can be ensured and the likelihood of a common cause error occurring can also be reduced in an advantageous manner for the communication software.

Another embodiment provides for a separate cable connection to be provided for each communication path. In other words, the hardware also ensures true separation of the communication paths and thus reliable redundancy. This means that communication via the communication paths can be completely separate from and independent of one another in terms of hardware and software. This can be the case if a separate communication processor and a separate cryptography processor, each with a separate algorithm and a separate cable connection, are provided for each communication path. There can be provision for this for redundantly transmitting particularly critical data.

Another embodiment provides for a respective cryptography processor to be designed to combine its associated cryptography algorithm, or the cryptography algorithm it executes, with a separate communication paradigm. A communication paradigm can specify which signature method is to be applied to the data. A signature method or a method of secure onboard communication in the vehicle is in particular a way of appending a signature to the data to be communicated that ensures that the data that are transmitted are authentic and integral.

Random values can be used to prevent replay attacks on data transmission. The random component in the form of these random values is preferably present on all involved control units or nodes. A respective random value can be understood to be a value that can additionally be used for a respective signature calculation in order to prevent the replay attacks. The additional random component can improve the cryptographic protection further.

There are the following methods, for example, for generating the random values, and selection and/or combination of the different methods can increase security in the data communication further, since this allows common cause errors to be avoided:

(i) Challenge-Response (C/R):

The basic idea concerns communication between two nodes, one node representing the data sink and the other node representing the data source. If the data sink then requests authenticated data from the data source, the requestor (data sink) initially sends a random value in the request, and the data source then uses this random value for the subsequent cryptographic operation, for example the signature calculation. This method ensures a one-to-one relationship between the data source and the data sink. Each new data value always requires a request. The data source then transmits the payload data (i.e. the requested data) and the calculated signature in response to the request.

(II) Session-Based Challenge-Response:

To prevent constant requests in the case of cyclic data, the session-based challenge-response method can be used. The transmitted random value of the data sink and a counter of the data source are included in the calculation of the signature. The payload data, the counter and the calculated signature are now transmitted.

(iii) Distribute Random Value Using C/R and Then Count Continuously:

To achieve stable broadcast transmission on a CAN bus (Controller Area Network bus, also referred as CANbus), a different approach is preferred. This approach requires an additional node in the network, which can be referred to as a random server, for example, and is situated in the network as a logical node. This node generates a random number when the system is started, for example when the motor vehicle's system is started, and increments it continuously. Additionally, after the system has started, all relevant nodes use C/R to ask this additional node for this value (the random number). Each node continuously increments the random number according to the same rule as the random server, with the result that the incremented value is always the same in all control units. The data source then uses this incremented value for the subsequent cryptographic operation to calculate the signature. The payload data and the calculated signature are now transmitted. The data sink can then check the signature.

In relation to this, one embodiment provides for a first communication paradigm to provide for a first data signature to be generated for the data when they are communicated via a first of the communication paths, in particular via the main path, by adding a method for generating a first random value, and for a second communication paradigm to provide for a second data signature, which is different from the first data signature, to be generated for the data when they are communicated via another of the communication paths, in particular via the fallback path, by adding a method for generating a second random value, the random values being generated differently. The method for generating the first and/or the method for generating the second random value can be one of the methods (i) to (iii) described above.

In other words, a first communication paradigm can provide for the data to be provided with a first random value centrally when they are communicated via a first of the communication paths, in particular via the main path. The data can then be provided with a first data signature, which is calculated by adding the first random value. Preferably, a second communication paradigm provides for the data to be provided with a second random value when they are communicated via another of the communication paths, in particular via the fallback path. The data can then be provided with a second data signature, different from the first data signature, which is calculated by adding the second random value.

In a specific illustrative application, the nodes can be subject to the following for communication via the main path: replay protection is ensured by virtue of all nodes incrementing from a randomly selected initial value in the same way and the result of the counting being fed into the cryptography algorithm, which generates the first data signature therefrom (cf. method (iii)). The nodes can be subject to the following for communication via the fallback path: a communication-specific or session-based approach is used for operation and therefore to generate the data signature (cf. method (ii)). As the data signature methods described are inherently known, no further detail will be provided here. Broadly speaking, according to the embodiment described here, a first random value is generated in the main path in order to provide replay protection, while a second random value is generated in the redundancy path in another way in order to provide replay protection here as well and to minimize common cause errors.

This emphasizes that, according to the embodiment described here, different data signature methods are used for the different communication paths in order to further increase the redundancy. Alternatively or additionally, different software suppliers or so-called libraries can also be used to increase the variability in the transmission paths even further.

The communication network can be in the form of a CAN BUS or in the form of a FlexRay BUS or an Ethernet network or can comprise these, each of the communication paths preferably being used by a multiplicity of nodes to participate in the communication of the data.

Another aspect of the invention relates to a motor vehicle having a communication network. The motor vehicle according to the invention is preferably in the form of a motor car, in particular a passenger car or truck, or in the form of a minibus or motorcycle.

Another aspect of the invention relates to a method for redundantly communicating data in a communication network that comprises at least two parallel communication paths, in particular a main path and a fallback path, which provide the redundant communication of the data in the communication network. The method comprises at least the steps of
providing at least one cryptography processor in a cryptography layer of the communication network,
providing at least two different cryptography algorithms for the at least one cryptography processor,
the at least one cryptography processor cryptographically protecting the data to be communicated along the parallel communication paths by virtue of the at least one cryptography processor applying a different one of the different cryptography algorithms to the data for each of the communication paths, and
communicating the data that are, in particular differently, cryptographically protected or handled in this way on the redundant communication paths.

For applications or application situations which may arise for the method and are not explicitly described here, there can be provision for the method to involve an error message and/or a request to input user feedback being output and/or a default setting and/or a predetermined initial state being set.

The invention also includes the control apparatus for the motor vehicle. The control apparatus can comprise a data processing apparatus or a processor device (processor circuit) configured to carry out an embodiment of the method according to the invention. For this purpose, the processor device can have at least one microprocessor and/or at least one microcontroller and/or at least one FPGA (field-programmable gate array) and/or at least one DSP (digital signal processor). In particular, a CPU (central processing unit), a GPU (graphical processing unit) or an NPU (neural processing unit) can each be used as the microprocessor. In addition, the processor device can have program code configured so as, when executed by the processor device, to carry out the embodiment of the method according to the invention. The program code may be stored in a data memory of the processor device. The processor device can be based e.g. on at least one circuit board and/or on at least one SoC (system on chip).

The invention also includes developments of the method according to the invention and/or of the motor vehicle according to the invention which have features as have already been described in connection with the developments of the communication network according to the invention, and vice versa. For this reason, the applicable developments of the method according to the invention and/or of the motor vehicle according to the invention are not described again here.

The invention also comprises the combinations of the features of the described embodiments. The invention thus also comprises implementations that each have a combination of the features of several of the described embodiments, unless the embodiments have been described as being mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

Exemplary embodiments of the invention are described below. In this regard:

FIG. 1 shows a schematic representation of a communication network according to an embodiment of the invention;

FIG. 2 shows a schematic representation of another example of a communication network having a main path and a redundancy path;

FIG. 3 shows a schematic representation of another illustrative configuration of a communication network having redundant communication paths;

FIG. 4 shows a schematic representation of a motor vehicle having a communication network according to an embodiment of the invention; and

FIG. 5 shows a schematic representation of a method for redundantly communicating data in such a communication network.

### DETAILED DESCRIPTION

Reference will now be made in detail to the preferred embodiments, examples of which are illustrated in the accompanying drawings, wherein like reference numerals refer to like elements throughout.

The exemplary embodiments explained below are preferred embodiments of the invention. In the exemplary embodiments, the described components of the embodiments each represent individual features of the invention that should be considered independently of one another and that each also develop the invention independently of one another. The disclosure is therefore also intended to comprise combinations of the features of the embodiments other than those illustrated. In addition, the described embodiments can also be supplemented by more of the features of the invention that have already been described.

In the figures, identical reference signs denote functionally identical elements in each case.

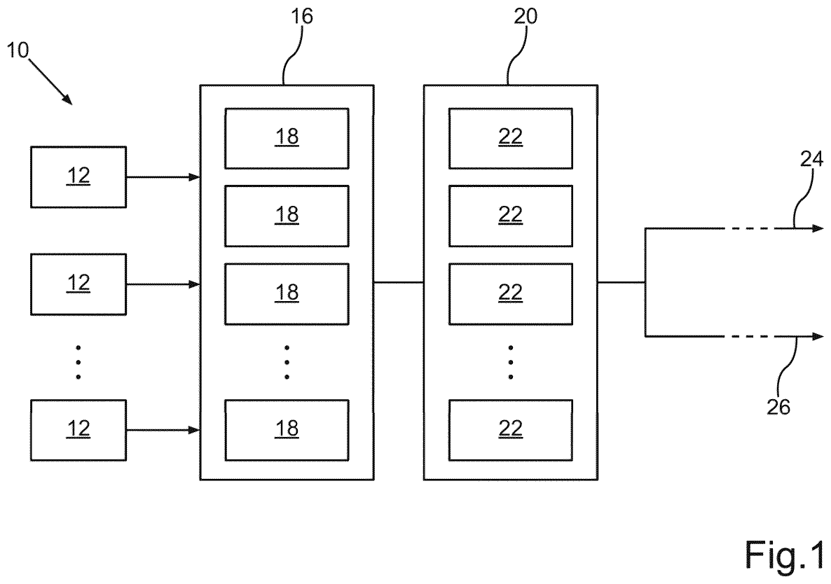

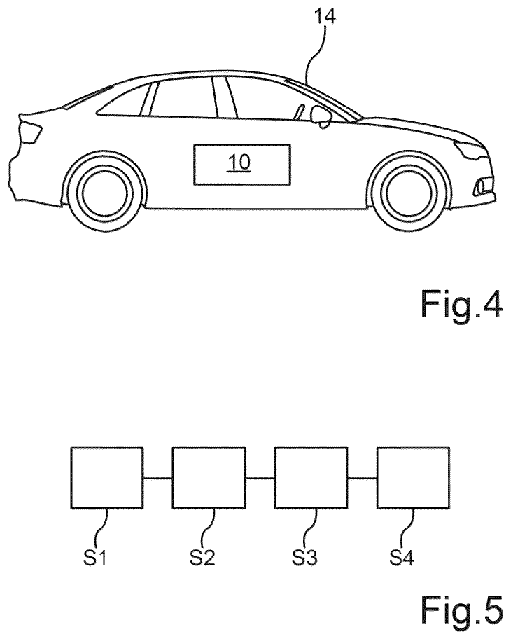

FIG. 1 shows a schematic representation of a communication network 10. In the illustrative embodiment shown, the communication network 10 comprises multiple nodes or control units 12 on the data-producing side. In other words, the nodes 12 in the example shown feed data to be transmitted into the communication network 10. The nodes 12 can be, for example, different control units or sensors or sensor systems of a motor vehicle 14 (FIG. 4) that communicate their data to a control apparatus, for example, which is not shown here, of the motor vehicle 14.

The sensor data can initially be fed from the sensors, i.e. the nodes 12, into a communication layer 16 of the communication network 10. Here, they can be distributed to communication processors 18 of the communication layer 16 via appropriately designed and inherently known data interfaces. The distribution can already be carried out according to a predetermined prioritization of the sensors. For example, the sensors can be distributed in a manner prioritized according to the criticality of the data they provide for a specific process in the motor vehicle 14. The process can be, for example, automated control of various actuators in the motor vehicle 14 that, for example, influence the driving behavior of the motor vehicle 14. In order to be able to carry out this process smoothly, for example data from sensors of an environment sensor system of the motor vehicle 14, for example data from radar, lidar and/or ultrasonic sensors, can be prioritized higher than, for example, data from a rain sensor for detecting rain drops on a windshield of the motor vehicle 14, to name but one typical example.

In a cryptography layer 20 of the communication network 10, which, here, is connected downstream by way of illustration, the data can then be assigned to individual cryptography processors 22. By way of example, this can again be done in a manner prioritized on the basis of the aforementioned criticality. In an extreme example, all data can also be duplicated and a respective complete dataset of a node 12 can be assigned to each of the communication and/or cryptography processors 18, 22.

The cryptography processors 22 can then apply one or more cryptography algorithms to the data, the cryptography algorithms differing from one another. In other words, the data are handled differently by each of the cryptography processors 22. There can also be provision for only a single cryptography processor 22 on the cryptography layer 20, said cryptography processor applying different cryptography algorithms to the data, resulting in the data being sent to the redundant communication paths 24, 26 of the communication network 10 with different cryptographic protection. The receiver side for the data is not shown here. This may be the control apparatus of the motor vehicle 14, in which the applicable receiver software can then be applied to the data to remove the cryptographic protection.

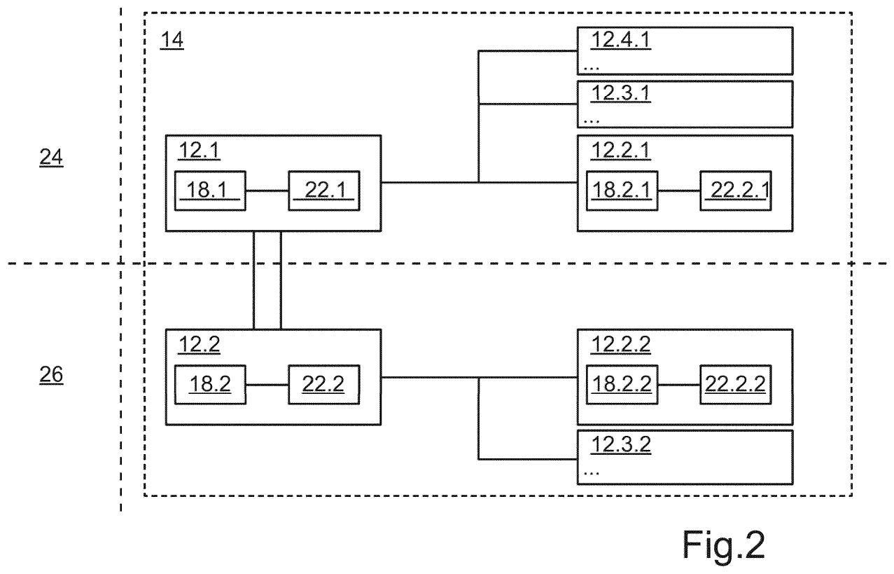

FIG. 2 shows another example of a communication network 10 having a main path 24 and a redundancy path 26. The same, or similar, tasks can be performed on the main path 24 and the redundancy path 26. By way of example, the communication network 10 shown here can comprise the following components with the indicated responsibilities:
the control unit 12.1 and the control unit 12.2 are responsible for path planning. These two control units 12.1, 12.2 are connected to one another with high bandwidth for communication purposes, but may be in a physically separate arrangement from one another, for example in different housings;
the control unit 12.2.1 and the control unit 12.2.2 are responsible for steering the motor vehicle 14;
the control unit 12.3.1 and the control unit 12.3.2 are responsible for braking the motor vehicle 14;
the control unit 12.4.1 is responsible for propelling the motor vehicle 14.

In a high-availability system for SAE level 3 and higher, therefore, generally not all control units 12 involved are mirrored in the redundancy path 26. In the example shown, the control unit 12.4.1, which provides for propulsion, would as such not necessarily be required in the redundancy path 26 if, in the event of a fault, the motor vehicle 14 then only has to be steered and braked, for example, until it is at a standstill.

Between the main path 24 and the redundancy path 26 there may be other connections and/or different connections than those shown. In the application, for example further connections can be used to detect whether one of the paths 24, 26 is no longer available and/or, if one control unit 12 in the main path 24 fails, there is still a desire to use as many other capacities of the main path 24 as possible, since said main path may perhaps exhibit better performance than the redundancy path 26.

As shown, each of the control units 12.1 and 12.2 comprises a separate communication processor 18.1 and 18.2 and a separate cryptography processor 22.1 and 22.2. It is therefore possible to use different cryptomethods or cryptoalgorithms on the main path 24 and on the redundancy path 26. In other words, cryptomethods or cryptoalgorithm A can be used in the main path 24, and cryptomethods or cryptoalgorithm B can be used in the redundancy path 26.

In the example shown, it is irrelevant how many connections there still are between the redundancy path 26 and the main path 24 and how many other networks exist in the main path 24: cryptomethod A must be used in the main path 24.

Alternatively or additionally, in the example of FIG. 2, further control units 12 with further networks to the control units 12.1 and 12.2, e.g. control units that are responsible for the sensor system, may also be provided to the left of the control units 12.1 and 12.2. For example there could also be provision for one or more cameras in the main path 24, and there could also be provision for radar and/or lidar sensors in the redundancy path 26, each of these being adopted in the control units 12.1 and 12.2.

All control units 12 involved can each have separate communication processors 18 and cryptoprocessors 22.

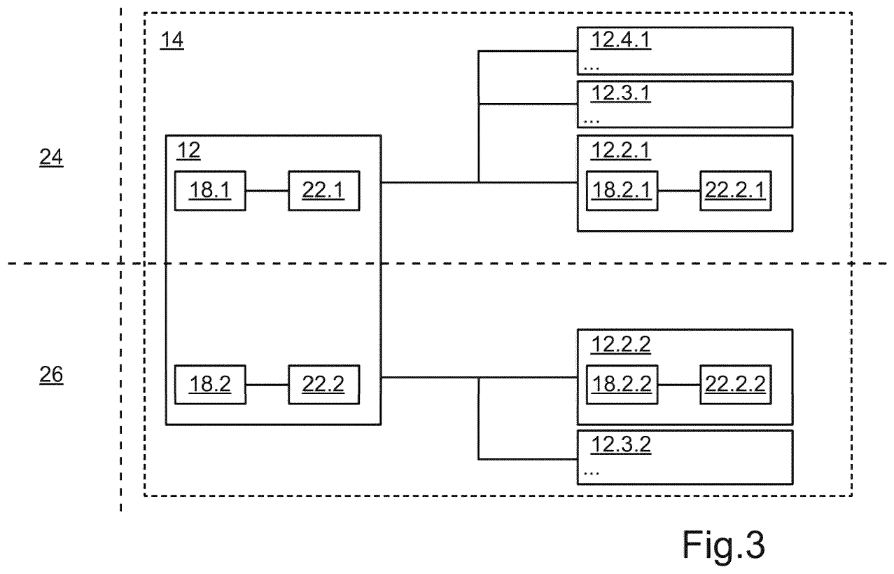

FIG. 3 shows another illustrative configuration of a communication network 10 having redundant communication paths 24, 26. In contrast to the example of FIG. 2, where there is provision for two control units 12.1 and 12.2 connected to one another with wide bandwidth for communication purposes, the example of FIG. 3 shows a single, in particular higher-level control unit 12 having an arbitrary number of forms of communication processors 18 and cryptography processors 22 (here, by way of illustration, two each: the communication processor 18.1 and the cryptography processor 22.1 for the main path 24, on the one hand, and the communication processor 18.2 and the cryptography processor 22.2 for the redundancy path 26, on the other).

In order to get the motor vehicle 14 into a safe state when performing a driving maneuver, for example, the brake, for example, should preferably be controllable by means of two redundant network/data connections (that is to say the main path 24 and the redundancy path 26), so that at least one path can be used to receive data. In the example of FIG. 3, therefore, a brake control unit 12.3.1 is provided both in the main path 24 and in the redundancy path 26 (referred to there as the brake control unit 12.3.2). In order to avoid so-called common cause errors here, different cryptography methods are used. In order to increase the redundancy further, there can be provision for further control units, for example for steering the motor vehicle 14, which perform a different driving function but have the same requirements, for example the brake control unit described.

The illustrative embodiments shown in FIGS. 2 and 3 do not, of course, reflect the communication networks 10 fully. The technical reality is a little more complex because different intermediate stations and network systems are used. Redundant data transmission is only part of the whole concept to ensure the safety of level 3 driving (or higher).

With reference to the components denoted and described in connection with FIG. 1 to 3, FIG. 4 shows a motor vehicle 14 having a communication network 10. The various sensors or other possible nodes or control units 12 on the communication network 10, all of which can be components of the motor vehicle 14, are not shown separately here for the sake of clarity.

With reference to the components denoted and described in connection with the figures described above, FIG. 5 shows a schematic representation of a method for redundantly communicating data in a communication network 10.

The communication network 10 can comprise at least two parallel communication paths 24, 26, in particular a main path and a fallback path, which provide the redundant communication of the data in the communication network 10. In a step S1, at least one cryptography processor 22 is provided in a cryptography layer 20 of the communication network 10. In a step S2, at least two different cryptography algorithms are provided for the at least one cryptography processor 22. In a step S3, the data to be communicated along the parallel communication paths 24, 26 are cryptographically protected by the at least one cryptography processor 22 by virtue of said cryptography processor applying a different one of the different cryptography algorithms to the data for each of the communication paths 24, 26. Finally, in a step S4, the data that are differently cryptographically protected in this way are communicated on the redundant communication paths 24, 26.

Today's vehicle communication is often protected by means of security protection mechanisms. For CAN and FlexRay communication, this can be accomplished using secure onboard communication (also referred to as SecOC for short, according to the AUTOSAR standard), which can comprise a standard component and a manufacturer-specific component. This concept can sometimes also be used for Ethernet communication.

Currently, vehicles are being developed that are capable of meeting SAE level 3 for autonomous driving. To achieve the requisite safety properties for autonomous driving, such as availability, it is advantageous to simultaneously send messages via different network channels (main path and fallback path).

Generally, only a single cryptography algorithm is used to cryptographically protect the data. However, the exclusive use of a single cryptography algorithm increases the likelihood of so-called common cause errors occurring. Common cause errors in risk analysis are failures of multiple components or systems that occur as a result of a single cause of error or a single event. The failure behavior of said components or systems is thus statistically dependent on one another. Common cause errors can lead to elimination of the necessary redundancies in safety-related safety subsystems.

To minimize common cause errors, it is advantageous to use different cryptography algorithms for the redundant communication paths. For example, SipHash could be used in one path and AES could be used in the other as cryptography methods. In combination with different communication paradigms (e.g. broadcast with freshness from the random server in the main path and unicast with session-based freshness in the fallback path), better independence could be achieved, for example also using the described random values (cf. described methods (i) to (iii)).

Sensible combination of differently selected cryptomethods can minimize the occurrence of so-called common cause errors when redundant communication is required. This improves the feasibility of autonomous driving functions.

A suitable configuration and use of different cryptography algorithms can be selected for this purpose. To achieve further independence, different software libraries (also referred to as libs) can also be used in addition to the different algorithms.

Overall, the examples show how to ensure high availability given secure vehicle communication.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1. A communication network for a motor vehicle, comprising:
at least two parallel communication paths including a main path and a fallback path, which are designed to provide a redundant communication of data in the communication network, the communication network (including a communication layer, which has at least one communication processor to organize communication of the data, and a cryptography layer, which has at least one cryptography processor to cryptographically protect the data to be communicated,
wherein the at least one cryptography processor is designed to cryptographically protect the data to be communicated along the at least two parallel communication paths by applying at least two different cryptography algorithms.

2. The communication network according to claim 1, wherein the cryptography layer comprises a multiplicity of cryptography processors including the at least one cryptography processor, each cryptography processor having a separate associated cryptography algorithm.

3. The communication network according to claim 1, wherein the communication layer comprises a multiplicity of communication processors, each communication processor having a separate associated communication algorithm.

4. The communication network according to claim 2, wherein the communication layer comprises a multiplicity of communication processors, each communication processor having a separate associated communication algorithm.

5. The communication network according to claim 1, wherein a separate cable connection is provided for each communication path.

6. The communication network according to claim 2, wherein a separate cable connection is provided for each communication path.

7. The communication network according to claim 3, wherein a separate cable connection is provided for each communication path.

8. The communication network according to claim 1, wherein the at least one cryptography processor is designed to combine an associated cryptography algorithm with a separate communication paradigm.

9. The communication network according to claim 2, wherein a respective cryptography processor among the multiplicity of cryptography processors is designed to combine an associated cryptography algorithm with a separate communication paradigm.

10. The communication network according to claim 8, wherein a first communication paradigm provides for a first data signature to be generated for the data based on the data being communicated via one communication path of the at least two parallel communication paths by adding a method for generating a first random value, and
wherein a second communication paradigm provides for a second data signature, which is different from the first data signature, to be generated for the data based on the data being communicated via another communication path of the at least two parallel communication paths by adding a method for generating a second random value.

11. The communication network according to claim 10, wherein the one of the least two parallel communication paths is the main path.

12. The communication network according to claim 10, wherein the other of the least two parallel communication paths is the fallback path.

13. The communication network according to claim 1, wherein the communication network is in a form of a CAN BUS or in a form of a FlexRay BUS or in a form of an Ethernet network.

14. The communication network according to claim 1, wherein each of the least two parallel communication paths is used by a multiplicity of nodes (to participate in the communication of the data.

15. A motor vehicle having the communication network according to claim 1.

16. A method for redundantly communicating data in a communication network enabled to communicate with a motor vehicle, the method comprising:
providing at least one cryptography processor in a cryptography layer of a communication network having at least two parallel communication paths including a main path and a fallback path, which provide redundant communication of the data in the communication network;
providing at least two different cryptography algorithms for the at least one cryptography processor designed to cryptographically protect the data to be communicated along the at least two parallel communication paths by virtue of the at least one cryptography processor applying a different one of the at least two different cryptography algorithms to the data for each of the communication paths, and
communicating the data that is cryptographically protected through the at least two parallel communication paths.
